(19) United States
(12) Patent Application Publication
(10) Pub. No.: US 2018/0099314 A1
(43) Pub. Date: Apr. 12, 2018

(54) SYSTEM AND METHOD FOR SORTING POSTAL ITEMS

(71) Applicant: SIEMENS AKTIENGESELLSCHAFT, MUENCHEN (DE)

(72) Inventor: PETER BERDELLE-HILGE, KONSTANZ (DE)

(21) Appl. No.: 15/728,688

(22) Filed: Oct. 10, 2017

Related U.S. Application Data
(60) Provisional application No. 62/406,263, filed on Oct. 10, 2016.

(51) Int. Cl. B07C 3/02; B07C 3/00

(52) U.S. Cl. CPC B07C 3/02; B07C 3/008

(57) ABSTRACT

A sorting technique is implemented to sequence individual flat items to a carrier route walk sequence by a postal system that utilizes automatic pocket sweeping to parse a sequence stream of mail items between multiple carriers.

### CROSS-REFERENCE TO RELATED APPLICATION

This application claims the benefit, under 35 U.S.C. § 119(e) of provisional patent application No. 62/406,263, entitled System and Method for Virtual Separations, filed Oct. 10, 2016.

### BACKGROUND OF THE INVENTION

### Field of the Invention:

The invention pertains to physical sorting and, more specifically, aspects of the present invention generally relate to postal sorting techniques including methods to sequence individual flat items to a carrier route walk sequence.

Postal sorting techniques involve grouping each item in individual stops and sequencing those stops to the route a carrier travels while performing their delivery. The method includes feeding and sorting in two or more passes. The conventional method is described in U.S. Pat. No. 9,205,461 B2 and is referred to as a RADIX sort.

Theoretically the number of pockets available for sequencing for each pass can be multiplied to derive the number of sequences that can be sorted. An example shows that if there are 10 pockets available in a first pass and 10 pockets available in the second pass, 100 sequences can be sorted and sequenced. Adding a third pass raises the number of sequences to 1,000. In practice, the mail has to be segregated in sorting machine pockets to individual carriers and is dependent on the number of carriers and the number of stops each carrier has to deliver, so two or more carriers mail cannot be mixed in the same pocket. Today the problem is solved by adding additional pockets to the second or third pass process. For example, sequencing 12 carriers requires a minimum of 12 second pass pockets so that two carrier's mail is not sent to the same pocket even though the total number of stops could be 100 or less.

Additionally, when the number of stops for a single carrier exceeds the number of first pass pockets available for sequencing, the mail has to be wrapped. For example, a 10 pocket machine sorting a carrier with 11 stops will need to put the eleventh stop in the same pocket as his first stop during pass one. Because the mail is randomly mixed within the pocket one during first pass, the second pass will require an additional pocket to sort the eleventh mail piece to a different pocket even though the total number of stops that could be sequenced are 100 or less.

Adding additional pockets to a sorter adds overhead, is expensive, is not an efficient use of hardware resources and takes up valuable footprint in a facility.

The RADIX algorithm based sort plan generation for the Delivery Point Sequencing (DPS) sort as used by the postal services today is developed for a manual mail handling at the machines. It is sorting the N^{th} stop of the different carriers to the N^{th} pocket in the first pass, thus having one or more pockets in the second pass dedicated to one carrier only. With this sort plan structure, the carrier boundaries are system immanent correlated between multiple pockets.

Methods to reduce the number of pockets required for sequencing have been described in U.S. Pat. No. 9,205,461 B2. The method is referred to as a Radix Plus or multiplication, but the hardware required to perform the functionality is expensive and the cost benefit ratio is very low compared to adding pockets. Most importantly, multiplication does not solve the issue caused by wrapping delivery points in pass one and segregating the wraps and carriers in the second pass.

### DETAILED DESCRIPTION OF THE INVENTION

The components and materials described hereinafter as making up the various embodiments are intended to be illustrative and not restrictive. Many suitable components and materials that would perform the same or a similar function as the materials described herein are intended to be embraced within the scope of embodiments of the present invention.

This invention describes a sorting technique to sequence individual flat items to a carrier route walk sequence for a postal system by utilizing automatic pocket sweeping.

This invention describes a system and method for reducing the number of pockets required to sequence flat artifacts. Methods are described for automatically sweeping a pocket in U.S. Pat. No. 7,112,031 B2 and U.S. Pat. No. 7, 207,560 B2. Another method was implemented in the Siemens Mail Cartridge System in the early 2000. The system and method for virtual separations is contingent on a automated process for sweeping pockets.

The process starts by calculating the number of stops in a given sort plan and assigning a sequence order to each stop regardless of the number of carriers or stops per carrier. For example, a sort plan that had 73,185 stops would assign a stop order for each stop of 1 through 73,185. The stop order is assigned a low byte (base N) and a high byte (base N). The number of the low byte is based on the number of available sequencing pockets in the first pass. The number of the high byte is the number of sequencing pockets avaiable in the second pass. For example, if there are 255 pockets available in the first pass, each sequence low byte number will be assigned a number from 0-254 (base 255) depending on its sequence order. All mail is sorted in the first pass to one of 255 pockets by sorting to the low byte. Each pocket in the first pass will contain a unique low byte regardless of the high byte value. The mail will be fed in pocket order during second pass, which means all the mail from pocket 1 will be fed before mail from pocket 2 is fed. In our example this process will continue for all first pass sequencing pockets (1234 . . . 255).

In the second pass, there are 287 pockets available, so the high byte will be a number from 0 to 286 (base 287). During the second pass, mail is sorted by the high byte to one of 287 pockets. This mail is fed in pocket order from the first pass separation during the second pass which means the lowest number low byte will be sorted first followed by next sequential byte. All low bytes will be fed in ascending order resulting in all the mail sequenced at the end of the second pass.

Table 1, below, is an example of the low and high byte structure used in the sorting process:

TABLE 1
Sequencing Sorting Methodology

| Sequence | | Carrier | Stop |
|---|---|---|---|
| High Byte | Low Byte | # | # |
| 0 | 0 | 1 | 1 |
| 0 | 1 | 1 | 2 |
| 0 | 2 | 1 | 3 |
| 0 | 3 | 1 | 4 |
| . . . | . . . | . . . | . . . |
| 0 | 253 | 2 | 98 |
| 0 | 254 | 2 | 99 |
| 1 | 0 | 2 | 100 |
| 1 | 1 | 2 | 101 |
| 1 | 2 | 3 | 1 |
| 1 | 3 | 3 | 2 |
| 1 | 4 | 3 | 3 |
| . . . | . . . | . . . | . . . |
| 286 | 252 | 150 | 598 |
| 286 | 253 | 150 | 599 |
| 286 | 254 | 150 | 600 |

According to the sequence sorting methodology shown in Table 1, sorting destinations in pass two may contain delivery sequences for multiple carriers, which would represent a problematic situation. This invention resolves that problem to provide containers of sequenced mail for individual carriers by dynamically parsing and incrementally redirecting the second pass sequence to multiple physical destinations, without altering the sorting methodology.

In a sorting machine, a single population of mail items is divided to multiple accumulation points at physical separations that are part of the machine, typically physical output pockets, bins, or chutes. As items are sorted among the output pockets or chutes, the capacity limit of these pockets or chutes is monitored, so that the sorted items can be removed from the chute or pocket and transferred to a container. Typically, the physical chutes or pockets are either numbered, or are formally designated according to destination.

Improved automation techniques have made it possible to automatically unload chutes or pockets. In an automatic environment, when a chute or pocket reaches its capacity, a signal is sent to the unloading system, which unloads the chute or pocket and transfers the contents to a container. It is often necessary to withhold sorting to the physical chute or pocket during the automatic unloading process. To maintain productivity while withholding items from being directed to a chute or pocketing which is currently being unloaded, the following process may be used:
a) Maintain one or more unallocated physical sorting chutes or pockets.
b) Sense that an active sorting chute or pocket is near its capacity limit.
c) Allocate an unused chute or pocket.
d) Transfer chute or pocket destinations from the chute or pocket being swept to the newly allocated chute or pocket.
e) Deallocate the chute or pocket being unloaded automatically.
f) Automatically unload the chute or pocket.
g) Define the unloaded chute or pocket as an active, unused chute or pocket.

This, in effect, is a dynamic bin allocation process. A given item that would be on its way to a given bin, which bin is being unloaded at that point, is instead delivered to a different bin. The term “withholding” and “withheld,” therefore does not mean that the machine is stopped, or even slowed. Instead, the system dynamically allocates a different bin. This is made possible, in the automated system, by utilizing assignments of logical bins to physical bins.

In this process, sorting destinations are dynamic relative to physical destinations, and it becomes possible to determine specific points in the sequence of items being processed at which a chute or pocket will be unloaded. The subject invention utilizes this documented capability to parse a sequence stream of mail items between multiple carriers.

In the invention, as the sorting destinations are being determined, the carrier of the previous item sent to the same sorting destination is compared to the carrier of the current item being sent to that destination. If the two are the same, no action is taken. If the carriers for the sequential items for the same destination are different, the automatic unloading sequence described above is triggered between the two items. This results in containers of items sequenced according to the method described in Table 1, in which each container of sequenced items is associated with a single carrier.

Claim 1 covers either a 2 or 3 pass Radix sort. The description is clearly of a 2-pass, but 3-pass systems are relatively common in postal automation. As a two-pass offers the potential of sequencing the square of the number of bins, a three-pass is the bins cubed. It would be one more “byte” in the Radix sort.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

1. A postal system, comprising:
an automatic pocket sweeper configured to:
provide an automated sorting process for sweeping a plurality of chutes or pockets, the sorting process including a plurality of passes, wherein sorting destinations in the passes subsequent to a first pass of the plurality of passes contain delivery sequences for multiple carriers; and
provide containers of a sequenced mail for individual carriers by dynamically parsing and incrementally redirecting a sequence of items in passes subsequent to a first pass to multiple physical destinations without altering the sorting process.

2. The system according to claim 1, further comprising:
an unloading system configured to automatically unload the plurality of chutes or pockets when a chute or a pocket reaches its capacity, wherein a signal is sent to the unloading system which unloads the chute or the pocket and transfers contents of the chute or the pocket to a container.

3. The system according to claim 2, wherein, while a given chute or a given pocket is being unloaded, items that were destined for the given chute or the given pocket are redirected to a different chute or pocket, by implementing a process in which sorting destinations are dynamically allocated relative to physical destinations.

4. A method for sorting postal items, the method comprising:
carrying out an automated sorting process with an automatic pocket sweeper by sweeping a plurality of chutes or pockets, the sorting process including a plurality of passes, wherein sorting destinations in the passes subsequent to a first pass of the plurality of passes contain delivery sequences for multiple carriers; and
providing containers of a sequenced mail for individual carriers by dynamically parsing and incrementally redirecting a sequence of items in passes subsequent to a first pass to multiple physical destinations without altering the sorting process.

5. The method according to claim 4, which further comprises automatically unloading the plurality of chutes or pockets with an unloading system when a chute or a pocket reaches its capacity, and sending a signal to the unloading system which unloads the chute or the pocket and transfers contents of the chute or the pocket to a container.

6. The method according to claim 5, which comprises, while a given chute or a given pocket is being unloaded, redirecting items that were destined for the given chute or the given pocket to a different chute or pocket, by implementing a process in which sorting destinations are dynamically allocated relative to physical destinations.
